(19) United States
(12) Patent Application Publication
(10) Pub. No.: US 2008/0100919 A1
(43) Pub. Date: May 1, 2008

(54) LIGHT-SEPARATION APPARATUS

(76) Inventor: YAO-MIN CHANG, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/625,478

(22) Filed: Jan. 22, 2007

(30) Foreign Application Priority Data
Oct. 27, 2006 (TW) 095139832

(51) Int. Cl. G02B 27/14

(52) U.S. Cl. 359/634

(57) ABSTRACT

A light-separation apparatus is provided in this invention. The apparatus includes a light source, an output device, a first optical filter, a first circulator, a second optical filter, and a second circulator. The light source provides a primary light including a first, a second, and a third colored light. The first optical filter filters the first colored light from the primary light and generates a first filtered light. The first circulator receives the primary light from the light source and outputs the primary light to the first optical filter. The second optical filter filters the second colored light from the first filtered light and generates a second filtered light. The second circulator receives the first filtered light from the first optical filter and outputs the first filtered light to the second optical filter. The first and second circulators respectively direct the first and second colored lights to the output device.

### BACKGROUND OF THE INVENTION

1. Field of the Invention

This invention is related to an optical apparatus, and more particularly, to an optical apparatus for light-separation.

2. Description of the Prior Art

Present projectors include several types, such as digital light processing (DLP) projectors and liquid crystal on silicon (LCOS) projectors. The two types of projectors both have the advantages of simple optical-path design, high brightness, high contrast, etc. Therefore, the two types of projectors are broadly used in business projectors, home projectors, and large rear projection TVs.

In both DLP and LCOS projectors, color wheels are used to separate lights with different colors. In general, a color wheel is composed of filter glasses of four colors: red, green, blue, and white. Besides, a color wheel generally rotates at high speed. After being filtered by a color wheel, the red, green, blue, and white lights from a white light source sequentially pass the color wheel and are respectively projected to specific positions. Subsequently, these lights of the four colors are adjusted and integrated by other optical devices to compose full-colored images.

As known by those skilled in this art, to provide rotation power, a color wheel apparatus must include a motor that consumes considerably high power. Moreover, the attrition rate of color wheels that constantly rotate at high speed and in high temperature is high. In addition, in the aforementioned projecting mechanisms, lights are transmitted in the air. It is difficult to prevent lights from being lost or scattered.

### SUMMARY OF THE INVENTION

To solve the aforementioned problems, this invention provides a light-separation apparatus to replace color wheels in prior arts. In the light-separation apparatus, according to this invention, optical fibers can be used for transmitting light. Thus, the hardware configuration of the light-separation apparatus is more flexible than that of a color wheel. Furthermore, the problem that light may be lost or scattered can be prevented.

One preferred embodiment, according to this invention, is a light-separation apparatus. This apparatus includes a light source, an output device, a first optical filter, a first circulator, a second optical filter, and a second circulator.

The light source is used for providing a primary light. The primary light includes a first colored light, a second colored light, and a third colored light. The first optical filter is used for filtering the first colored light from the primary light and for generating a first filtered light. The first circulator receives the primary light from the light source and outputs the primary light to the first optical filter. After the first optical filter filters the first colored light from the primary light, the first circulator directs the first colored light to the output device. The second optical filter is used for filtering the second colored light from the first filtered light and for generating a second filtered light. The second circulator receives the first filtered light from the first optical filter and outputs the first filtered light to the second optical filter. After the second optical filter filters the second colored light from the first filtered light, the second circulator directs the second colored light to the output device.

The advantage and spirit of the invention may be understood by the following recitations together with the appended drawings.

### BRIEF DESCRIPTION OF THE APPENDED DRAWINGS

FIG. 1 shows the block diagram of the light-separation apparatus in the first preferred embodiment according to this invention.

FIG. 2 shows the block diagram of the light-separation apparatus in the second preferred embodiment according to this invention.

FIG. 3 shows the block diagram of the light-separation apparatus in the third preferred embodiment according to this invention.

### DETAILED DESCRIPTION OF THE INVENTION

One main purpose of this invention is to provide a light-separation apparatus. The light-separation apparatus, according to this invention, can be used in DLP and LCOS projectors. The light-separation apparatus can also be used in different kinds of optical systems that need to separate lights of different colors.

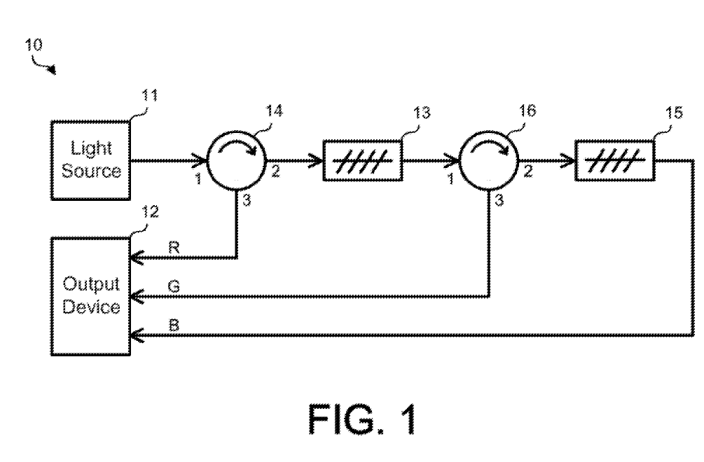

Please refer to FIG. 1, which shows the light-separation apparatus in the first preferred embodiment according to this invention. The light-separation apparatus 10 includes a light source 11, an output device 12, a first optical filter 13, a first circulator 14, a second optical filter 15, and a second circulator 16. In actual applications, the devices in the light-separation apparatus 10 can be connected with each other by optical fibers.

The light source 11 is used for providing a primary light. The primary light includes a first colored light, a second colored light, and a third colored light. For example, the primary light may be a white light. For more convenient and clearer explanations, in the embodiments below, the first colored light is assumed to be a red light (R), the second colored light is assumed to be a green light (G), and the third colored light is assumed to be a blue light (B). Actually, the primary light might include lights of other colors.

Correspondingly, in the embodiments below, the first optical filter 13 is assumed to be used for filtering red light. More specifically, the first optical filter 13 filters red light out from an input light and reflects the red light. The light of the other colors in the input light passes through the first optical filter 13. The second optical filter 15 is assumed to be used for filtering green light. In actual application, the first optical filter 13 and the second optical filter 15 can be chirp fiber Bragg gratings (CFBGs) respectively implemented on an array wave guide (AWG).

The first circulator 14 and the second circulator 16 in this embodiment are both 3-port circulators. As known by those skilled in this art, a circulator can direct light to be transmitted toward specific directions. Taking the first circulator 14 in FIG. 1 for example, the three input/output (IO) ports of the first circulator 14 are respectively labeled with numbers 1, 2, and 3. Generally, light entered into the number 1 IO port of the first circulator 14 is outputted from the number 2 IO port. Light entered into the number 2 IO port of the first circulator 14 is outputted from the number 3 IO port. Light entered into the number 3 IO port of the first circulator 14 is outputted from the number 1 IO port. The second circulator 16 works in the same way as the first circulator 14; thus, it is not further described.

The first circulator 14 receives the primary light from the light source 11 through the number 1 IO port and then outputs the primary light to the first optical filter 13 through the number 2 IO port. The red light in the primary light is filtered out by the first optical filter 13 and is reflected back to the first circulator 14. The light of the other colors in the primary light passes through the first optical filter 13 and becomes a first filtered light. The red light reflected back to the first circulator 14 enters the number 2 IO port of the first circulator 14 and then is outputted from the number 3 IO port of the first circulator 14. In other words, the first circulator 14 directs the red light to the output device 12.

The second circulator 16 receives the first filtered light from the first optical filter 13 through the number 1 IO port and outputs the first filtered light to the second optical filter 15 through the number 2 IO port. The green light in the first filtered light is filtered out by the second optical filter 15 and is reflected back to the number 2 IO port of the second circulator 16. Subsequently, the green light is directed from the number 3 IO port of the second circulator 16 to the output device 12. The light of the other colors in the first filtered light passes through the second optical filter 15 and becomes a second filtered light. If the primary light does not include light of other colors except red, green, and blue, the second filtered light is blue light.

As shown in FIG. 1, the red, green, and blue lights filtered out by the first optical filter 13 and the second optical filter 15 are respectively transmitted to the output device 12. In actual applications, the output device 12 can be an optical switch for selectively outputting the red, green, and blue lights. Accordingly, the light-separation apparatus 10 achieves the function of separating and providing lights of different colors.

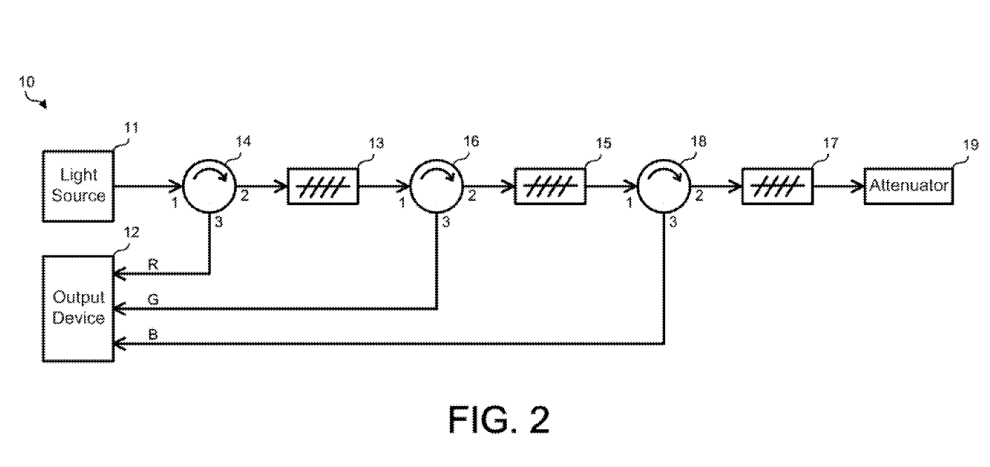

Please refer to FIG. 2, which shows the light-separation apparatus in the second preferred embodiment according to this invention. In this embodiment, the light-separation apparatus 10 further includes a third optical filter 17, a third circulator 18, and an optical attenuator 19.

If the primary light includes lights of other colors beside red, green, and blue, the third optical filter 17 can be used for filtering the blue light from the second filtered light. As shown in FIG. 2, the third circulator 18 receives the second filtered light from the second optical filter 15 and outputs the second filtered light to the third optical filter 17. After the third optical filter 17 filters the blue light from the second filtered light, the third circulator 18 directs the blue light to the output device 12. Light of other colors in the second filtered light passes through the third optical filter 17 and becomes a third filtered light. The optical attenuator 19 receives the third filtered light from the third optical filter 17 and attenuates the third filtered light. The third filtered light herein is usually a stray light.

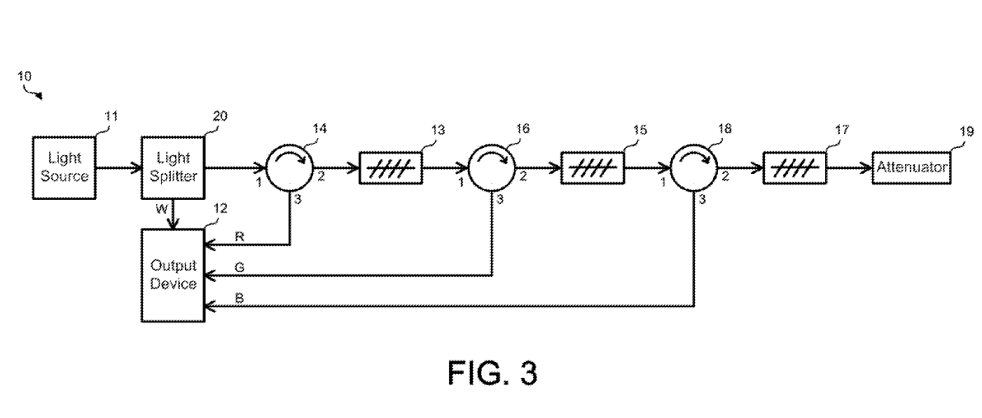

Please refer to FIG. 3, which shows the block diagram of the third preferred embodiment according to this invention. Compared with the prior embodiment, the light-separation apparatus 10 further includes a light splitter 20.

The light splitter 20 is disposed between the light source 11 and the first circulator 14. The light splitter 20 is used for splitting, with a specific ratio, the primary light into a first primary light and a second primary light. For instance, the light splitter 20 may split the white light outputted from the light source 11 into two portions. One portion of the white light is transmitted to the first circulator 14. The other portion of the white light (W) is directly outputted to the output device 12. Correspondingly, the output device 12 in this embodiment has four input terminals for respectively receiving the red, green, blue, and white lights. The output device 12 can be controlled to selectively output these lights of the four colors or output these lights periodically and sequentially. After the white light of a specific ratio is added, the image brightness provided by a projector can be increased.

The light-separation apparatus, according to this invention, can replace color wheels in prior arts. Because in the light-separation apparatus, according to this invention, optical fibers can be used for transmitting light, the hardware configuration of the light-separation apparatus is more flexible than that of an optical system in prior arts. Moreover, the problem that light may be lost or scattered can be prevented. In addition, the light-separation apparatus, according to this invention, can be used in DLP projectors, LCOS projectors, and other kinds of optical systems that need to separate light of different colors.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A light-separation apparatus, comprising:
a light source for providing a primary light, the primary light comprising a first colored light, a second colored light, and a third colored light;
an output device;
a first optical filter for filtering the first colored light from the primary light and generating a first filtered light;
a first circulator for receiving the primary light from the light source and outputting the primary light to the first optical filter, after the first optical filter filters the first colored light from the primary light, the first circulator directing the first colored light to the output device;
a second optical filter for filtering the second colored light from the first filtered light and generating a second filtered light; and
a second circulator for receiving the first filtered light from the first optical filter and outputting the first filtered light to the second optical filter, after the second optical filter filters the second colored light from the first filtered light, the second circulator directing the second colored light to the output device.

2. The light-separation apparatus of claim 1, wherein the primary light is a white light.

3. The light-separation apparatus of claim 1, wherein the first colored light is a red-colored light, the second colored light is a green-colored light, and the third colored light is a blue-colored light.

4. The light-separation apparatus of claim 1, wherein the second filtered light is the third colored light.

5. The light-separation apparatus of claim 1, wherein the output device is an optical switch for selectively outputting the first colored light or the second colored light.

6. The light-separation apparatus of claim 1, further comprising:
a third optical filter for filtering the third colored light from the second filtered light and generating a third filtered light; and
a third circulator for receiving the second filtered light from the second optical filter and outputting the second filtered light to the third optical filter, after the third optical filter filters the third colored light from the second filtered light, the third circulator directing the third colored light to the output device.

7. The light-separation apparatus of claim 6, further comprising:
an optical attenuator for receiving the third filtered light from the third optical filter and attenuating the third filtered light.

8. The light-separation apparatus of claim 6, wherein the output device is an optical switch for selectively outputting the first colored light, the second colored light, or the third colored light.

9. The light-separation apparatus of claim 1, further comprising:
a light splitter disposed between the light source and the first circulator, the light splitter being used for splitting the primary light into a first primary light and a second primary light, outputting the first primary light to the first circulator, and outputting the second primary light to the output device.

10. The light-separation apparatus of claim 9, wherein the output device is an optical switch for selectively outputting the first colored light, the second colored light, the third colored light, or the second primary light.

11. The light-separation apparatus of claim 1, wherein the output device, the first optical filter, the first circulator, the second optical filter, and the second circulator are connected with each other by optical fibers.

12. The light-separation apparatus of claim 1, wherein the first optical filter and the second optical filter are chirp fiber Bragg gratings (CFBGs).

13. The light-separation apparatus of claim 1, wherein the first optical filter and the second optical filter are respectively implemented on an array wave guide.
